(19) United States
(12) Patent Application Publication
(10) Pub. No.: US 2015/0053685 A1
(43) Pub. Date: Feb. 26, 2015

(54) COLLAPSIBLE BARREL

(71) Applicant: Jack Dean Sievers, Indianapolis, IN (US)

(72) Inventor: Jack Dean Sievers, Indianapolis, IN (US)

(21) Appl. No.: 13/974,871

(22) Filed: Aug. 23, 2013

(51) Int. Cl. B65D 33/02; B65D 21/08; B65D 41/22

(52) U.S. Cl. CPC B65D 33/02; B65D 41/22; B65D 21/086
USPC 220/485

(57) ABSTRACT

A collapsible barrel for use in training equine barrel racing. The collapsible barrel may include a wire frame and a sheath covering that may form a barrel shaped body. The barrel shaped body may include a top end and a bottom end. The bottom end may include a bottom surface with at least one eyelet. Stakes may be drive into the eyelets to secure the collapsible barrel to the ground.

### BACKGROUND OF THE INVENTION

The present invention relates to a collapsible barrel and, more particularly, to a collapsible barrel that may be secured to the ground.

Currently, practice barrels are for use in training for equine barrel racing. However, practice barrels are heavy and hard to maneuver. Further, the practice barrels take up valuable storage space when not in use or during transportation. Further, when the barrels are hit by the horse, the barrels move out of position.

As can be seen, there is a need for a lightweight collapsible barrel that may be secured to the ground.

### SUMMARY OF THE INVENTION

In one aspect of the present invention, a collapsible barrel comprises: a frame comprising at least one compressible wire; a sheath covering the frame forming a barrel shaped body comprising a top end, a bottom end, and a sidewall, wherein the top end forms an opening and wherein the bottom end comprises a bottom surface; and at least one eyelet sewn into the sheath at the bottom end of the barrel shaped body, wherein the at least one eyelet is configured to receive a stake, wherein the barrel shaped body is in a compressed form and an expanded form.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown with two different removable tops;

FIG. 2 is a perspective view of the embodiment of FIG. 1 further showing stakes and eyelets; and

FIG. 3 is a perspective view of the embodiment of FIG. 1 in a compressed form.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a collapsible barrel for use in training for equine barrel racing. The collapsible barrel may include a wire frame and a sheath covering that may form a barrel shaped body. The barrel shaped body may include a top end and a bottom end. The bottom end may include a bottom surface with at least one eyelet. Stakes may be driven into the eyelets to secure the collapsible barrel to the ground.

The present invention may include a collapsible barrel. The collapsible barrel may collapse on itself when not in use so that the barrel may take up less space during storage. Further, the present invention may include a unique bottom portion that is designed so that stakes may hold the barrel in place. This may eliminate the need for heavy objects, and therefore making the present invention easy to transport.

In certain embodiments, the bottom of the present invention may include a cross design or tabs as opposed to a solid bottom. The cross design of the device may make it easier to hang on a wall or to place on a shelf. In certain embodiments, the top cover of the barrel may be detachable and may include an attachment component such as a hook and loop fastener to hold the top in place. This may further facilitate easy access and storage. In certain embodiments, the present invention may include a pouch attached inside of the barrel to store the stakes.

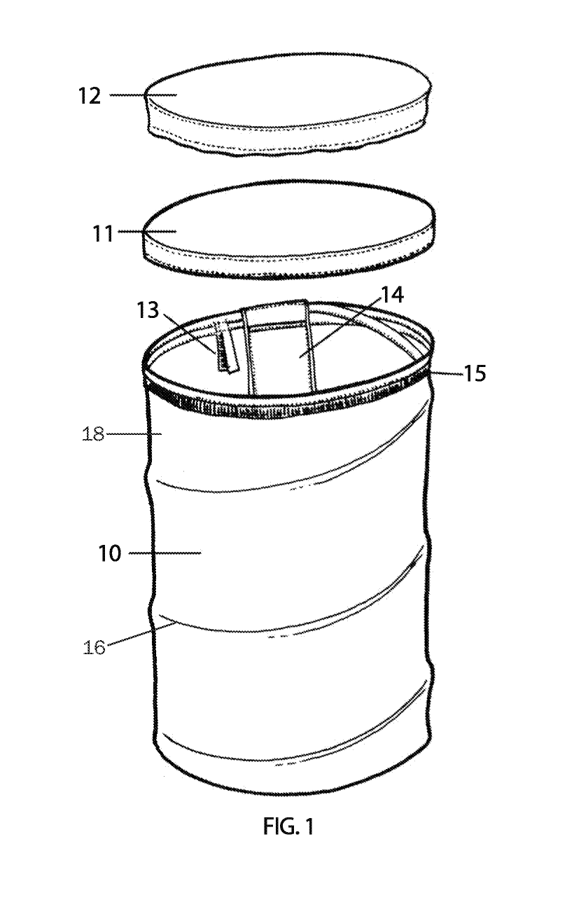

Referring to FIGS. 1 through 3, the present invention may include a frame 16 that may include at least one wire. The wire frame 16 may be similar to a spring that may be compressed and expanded. A sheath 18 covering made of a fabric material may cover the frame 18 to form a barrel shaped body 10. The barrel shaped body 10 may include a top end, a bottom end, and a sidewall. The top end may form an opening and the bottom end may include a bottom surface 17.

The barrel shaped body 10 may be in a compressed form and an expanded form. In certain embodiments, the frame 16 may be biased in the expanded form. To convert the barrel shaped body 10 to the compressed form, a user may push the top end and the bottom end together, so that the top end is adjacent to the bottom end.

In certain embodiments, the present invention may further include retention straps 13 attached to at least one of the top end and the bottom end. As illustrated in FIG. 1, the retention straps 13 may be secured to an inside surface of the sheath 18 near the top end of the barrel shaped body 10. The retention straps 13 may secure the top end and the bottom end together in the compressed form. To do so, the retention straps 13 may include an attachment component, such as a hook and loop fastener.

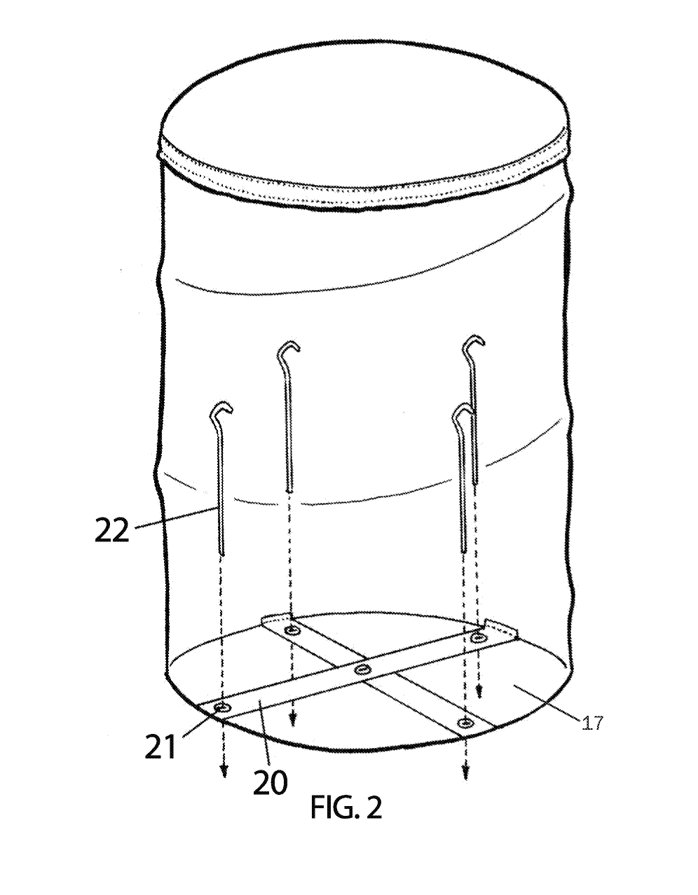

In certain embodiments, the bottom end of the barrel shaped body 10 may include at least one eyelet 21. The eyelet 21 may be embedded in the bottom surface 17 of the barrel shaped body 10. However, the eyelet 21 is not restricted to the bottom surface 17 and may be attached anywhere near the bottom end of the barrel shaped body 10. The eyelets 21 may receive a stake 22. Therefore, in the expanded form, a user may drive a stake 22 through the eyelet 21 and into the ground to secure the collapsible barrel to the ground. The present invention may further include strips of cloth 20 sewn to the bottom surface 17. The strips of cloth 20 may include the eyelets 21 and may add additional material to prevent damage. As illustrated in FIG. 2, the cloth strips 20 may be crossed.

The present invention may further include a top cover 11, 12 that may be secured to the top end of the barrel shaped body 10. The top cover 11, 12 may cover the top opening. In certain embodiments, the top cover 11 may include an elastic band lip to secure the top cover 11 to the top end of the barrel shaped body 10. In certain embodiments, the top cover 12 may include a hook and loop fastener. In such embodiments, the rim of the top opening may include a hook and loop fastener strip 15. Therefore, the top cover 12 may be secured to the hook and loop fastener strip 15.

In the expanded form, the collapsible barrel may be used during the training of equine barrel racing events. A user may drive the strakes 22 through the eyelets 21 and into the ground. This may secure the compressible barrel to the ground so that the barrels may retain their position when they are hit by the horse or during a strong gust of wind.

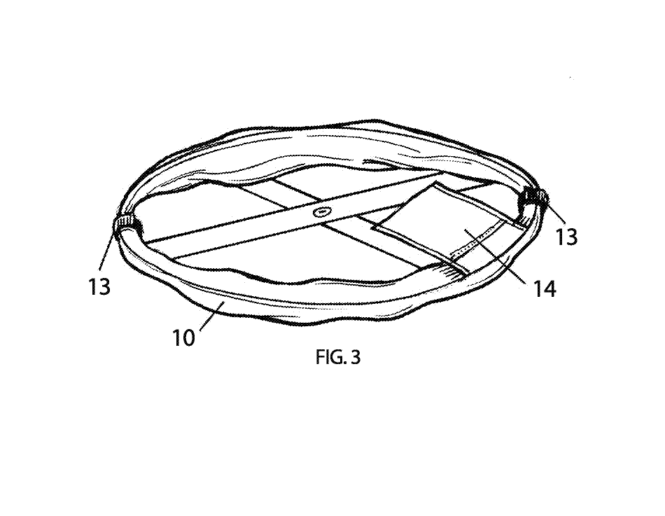

The collapsible barrel may be easily compressed into the compressed form. In the compressed form, a user may easily store the collapsible barrel in small spaces. To keep the components together, the collapsible barrel may further include a pocket 14. The pocket 14 may be sewn to the inside surface of the barrel shaped body 10. As illustrated in FIGS. 1 and 3, the pocket 14 may be sewn near the top end of the barrel shaped body 10. In the compressed form, the stakes 22 may be secured within the pocket 14 and the entire set may be stored in one area.

It should be understood, of course, that the foregoing relates to exemplary embodiments of the invention and that modifications may be made without departing from the spirit and scope of the invention as set forth in the following claims.

What is claimed is:

1. A collapsible barrel comprising:
a frame comprising at least one compressible wire;
a sheath covering the frame forming a barrel shaped body comprising a top end, a bottom end, and a sidewall, wherein the top end forms an opening and wherein the bottom end comprises a bottom surface; and
at least one eyelet attached near the bottom end of the barrel shaped body, wherein the at least one eyelet is configured to receive a stake,
wherein the barrel shaped body is in a compressed form and an expanded form.

2. The collapsible barrel of claim 1, wherein the at least one eyelet is sewn into the bottom surface of the barrel shaped body.

3. The collapsible barrel of claim 1, further comprising a first strip of cloth and a second strip of cloth sewn to the bottom surface of the sheath in a crossing pattern.

4. The collapsible barrel of claim 3, wherein the at least one eyelet is sewn into at least one of the first strip of cloth and the second strip of cloth.

5. The collapsible barrel of claim 1, further comprising a pocket attached to an inside surface of the sheath, wherein the pocket is configure to hold at least one stake.

6. The collapsible barrel of claim 1, wherein the barrel shaped body is biased in an expanded form.

7. The collapsible barrel of claim 6, wherein the compressed form comprises the top end adjacent to the bottom end.

8. The collapsible barrel of claim 7, further comprising retention straps attached to at least one of the top end and the bottom end, wherein the retention straps secure the top end and the bottom end together.

9. The collapsible barrel of claim 8, wherein the retention straps comprises a hook and loop fastener.

10. The collapsible barrel of claim 1, further comprising a top cover removably attached to the top end of the barrel shaped body.

11. The collapsible barrel of claim 10, wherein the top cover comprises an elastic rim that secures the top cover to the top end.

12. The collapsible barrel of claim 10, wherein the top cover comprises a hook and loop fastener and the top end comprises a hook and loop fastener.
